(19) United States
(12) Patent Application Publication
(10) Pub. No.: US 2024/0029041 A1
(43) Pub. Date: Jan. 25, 2024

(54) ADVANCED SERVICE STATION SYSTEM AND CONTROL PROCESS

(71) Applicant: ENI S.P.A., Roma (IT)

(72) Inventors: Roberto SALADINI, ROMA (IT); Massimo ROVATTI, PALERMO (IT); Alessandro MORETTI, ROMA (IT); Massimo BANCI, RIMINI (IT); Piersergio AVAGLIANO, Santarcangelo di Romagna (RN) (IT); Carlo PERICO, Mese (SO) (IT)

(21) Appl. No.: 18/024,645

(22) PCT Filed: Sep. 3, 2021
(86) PCT No.: PCT/IB2021/058068

§ 371 Date: Mar. 3, 2023

(30) Foreign Application Priority Data
Sep. 4, 2020 (IT) 102020000021049

(51) Int. Cl. G06Q 20/14; G06Q 20/20; G06Q 30/018

(52) U.S. Cl. CPC G06Q 20/145; G06Q 20/202; G06Q 30/018

(57) ABSTRACT

An advanced service station system includes a service station with a forecourt area having a forecourt terminal associated with a memory unit and dispenser. The forecourt terminal sends control signals to the dispenser and receives an actual datum that detects a quantity of fuel dispensed, the datum being stored in the memory unit and used to generate a local metrological certificate of the quantity of fuel dispensed.

The system includes a remote management centre with a central control module (with a central memory unit) that receives a signal having received data stored in the memory unit, the received data having the datum and data correlated to the datum and dispenser; and stores the received data in the central memory unit and processes the received data to generate a remote metrological certificate, which compared with the local metrological certificate allows to generate a remote metrological certificate of quantity of fuel dispensed.

### CROSS-REFERENCE TO RELATED APPLICATIONS

This application is a 35 U.S.C. § 371 National Stage patent application of PCT/IB2021/058068, filed on Sep. 3, 2021, which claims priority to Italian patent application 102020000021049, filed on Sep. 4, 2020, the disclosures of which are incorporated herein by reference in their entirety.

### TECHNICAL FIELD

The present disclosure relates to an advanced service station system.

More specifically, the disclosure relates to an advanced system comprising a service station equipped with a forecourt area comprising a forecourt terminal associated with at least one dispenser, to dispense a quantity of fuel, and a measurement detector block associated with said at least one dispenser to provide a local certificate of measurement of the quantity of fuel dispensed.

The disclosure also refers to a remote control process of the advanced service station system.

### BACKGROUND

Conventional service stations are fuel distribution systems for motor vehicles and must comply with the laws in force on metrological controls linked to the operating measuring tools. Therefore, the automatic distributors equipped with dispensers must be approved according to the laws and regulations applied in the country where they are installed.

Generally, the service stations have an approved computerised management device or management device which is located in the forecourt area and which is connected to and capable of managing the forecourt devices. The forecourt device comprises:
dispensers or automatic distributors;
forecourt terminals (TP) or payment terminals;
a measurement detector;
price indicators both of the Totem and over-pump types;
control unit of the level probes that are inserted in the fuel tanks;
payment terminals via EFT-POS that are arranged internally in a dedicated facility with an operator;
fiscal printer and non-tax printers;
non-oil item sales station that can be located inside or outside the facility.

The forecourt terminals or payment terminals are devices that are used for self-service refuelling with or without a service station attendant and accept different payment methods:
banknotes;
credit or debit bank cards;
payment cards of the oil company;
provider's cards that are linked to the service station.

The forecourt terminals substantially operate in two different modes that can be defined as “Slave” and “Master”.

In the “Slave” mode, the forecourt terminal acquires the payment, but the management device is the one that authorises the delivery of the fuel from the dispenser and which, by means of the measurement detector, records the quantity of fuel dispensed in a dedicated memory unit. The memory unit provided is a memory that allows to certify the data contained. Substantially, the memory allows data to be written uniquely and prevents or highlights any overwriting or tampering thereof.

In the “Master” mode, the forecourt terminal operates autonomously, i.e. it authorises the delivery of the paid quantity of fuel without the authorisation of the management device. In this case, the “Master” forecourt terminal comprises a memory unit which is individually approved for the metrological and fiscal aspects in accordance with the applicable legislation and regulations.

The management device or the “Master” terminal through the memory unit provide an archive of the data of the fuel sold that allows the generation of a measurement certificate, according to the laws in force, to guarantee the correct delivery of the quantity of fuel dispensed by the service station dispensers.

The companies that manage several service stations collect the data of the fuel sold, from each service station, by means of a connection, in a secure mode, to the memory unit of the management device or of the “Master” terminal to perform data collection with read access. Through the connection, in secure mode, it is possible to obtain further information on the active/inactive status of additional forecourt devices that are connected to the management device or the “Master” terminal by means of a local network.

The known solutions of systems and service stations, while satisfactory in many respects, have some drawbacks.

In fact, the service stations are substantially managed locally, i.e. they require an operator to be present in the forecourt area to make any change that involves a subsequent variation of the data adapted to generate the local measurement certificate. For example: the price of fuel, the type of fuel dispensed by a dispenser or the operational dispensing mode are managed by the operator on site.

Some known solutions involve solving this drawback by sending an executable program to the management device or “Master” terminal by means of a secure connection. However, the actual verification that the requested variation has also occurred locally, on the dispenser and/or recorded by the management device or the “Master” terminal, is only done by means of a verification with the operator in the forecourt area.

US 2010/023162—(Gresak Kristijan [SI] et al) describes a method and a system for operating the fuel distribution for unmanned self-service gasoline stations with a coordination center for generating an optimized delivery path for tank-vehicles in order to supply the fuel reservoirs to each forecourt area. The optimized path is determined on the basis of the amount of remaining fuel in the tank-vehicles and in the fuel reservoirs, such fuel amounts being periodically determined by sensors disposed in the tank-vehicles and in the fuel reservoirs.

U.S. Pat. No. 5,363,093 A—(Williams Barry N. [US] et al) describes an apparatus and a method of automatic monitoring of the level of the fuel, which is stored in underground storage tanks and that is dispensed by a pump and a dispenser. The hardware with level sensors and temperature detectors, that are disposed inside or outside of the storage tanks, and a set of algorithms are used to detect the volume of the fuel pumped daily for determining loss of fuel caused by equipment failure or pilferage of fuel.

US 2008/12621 3 A1 (Robertson Philip A. [US] et al) describes a peer-to-peer data replication system for off-line transactions in a service station equipped with payment terminals. The forecourt devices store each one and in a redundant mode the data related to the payment through a local communication network, such data being reproduced when the payment server is online.

The technical problem underlying the present disclosure is that of generating an automation of the service station allowing at the same time to certify the local forecourt data, creating a service station system that has structural and functional characteristics such as to overcome the limitations and the drawbacks which still limit the systems of the service stations realised according to the prior art.

### SUMMARY

The solution idea underlying the present disclosure is that of having a remote management and control of the local forecourt data of the service station.

On the basis of this solution idea, the technical problem is solved by an advanced service station system as described in claim 1.

The technical problem is also solved by a control process as described in claim 11.

The features and the advantages of the system and of the process according to the disclosure will result from the description below of embodiment examples given by way of non-limiting examples with reference to the attached drawings.

### BRIEF DESCRIPTION OF THE DRAWINGS

With reference to these figures,

FIG. 1 schematically illustrates an advanced service station system according to the present disclosure;

FIG. 2 schematically illustrates an arrangement of the devices in the forecourt area, in one embodiment;

FIG. 3 schematically illustrates an advanced system according to the present disclosure in a further embodiment; and

FIG. 4 schematically illustrates a further embodiment of an advanced system with a plurality of service stations.

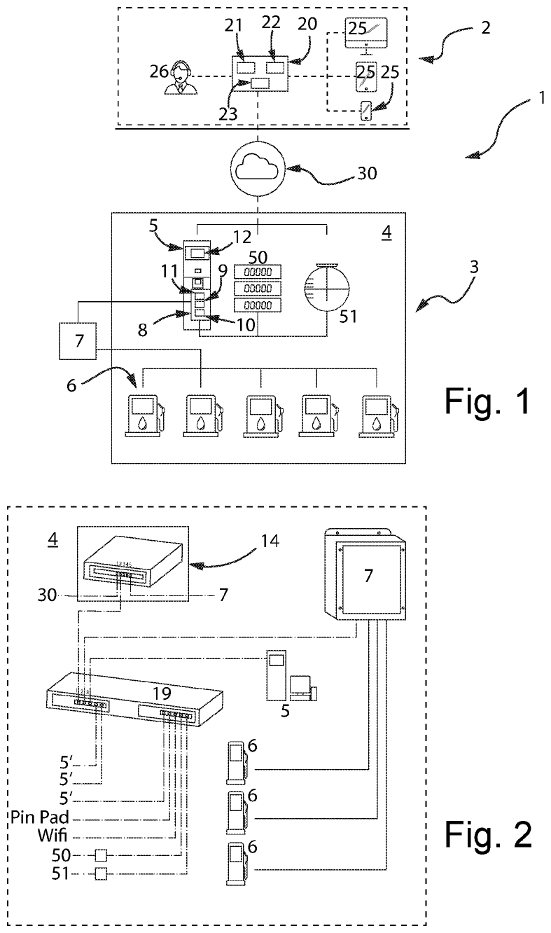

### DETAILED DESCRIPTION OF THE DRAWINGS

With reference to FIG. 1, the advanced service station system is globally indicated by number 1 and will be referred to as advanced system in the following description.

The advanced system 1 comprises a remote management centre 2 and a service station 3.

The service station 3 is equipped with a forecourt area 4 comprising at least one forecourt terminal 5 and a plurality of dispensers 6. The remote management centre 2 is arranged remotely with respect to said forecourt area 4 and communicates with the forecourt terminal 5 by sending and receiving signals through a communication network 30.

The forecourt terminal 5 which is a Master type terminal is associated with at least one dispenser 6 through a local network. Each dispenser 6 is configured to dispense a quantity of fuel according to a specific demand.

Substantially with regard to the scope of protection of this application, a legislation to which reference is made requires that the dispenser 6 is substantially fixed to the forecourt area 4 and therefore cannot be replaced/altered without a previous authorisation from a Certifying body. It is also required that the datum relating to the quantity of fuel dispensed be associated with the corresponding dispenser 6 and be kept unchanged, that is, it cannot be modified or modifiable in any way, neither by acting at the software level nor at the hardware level. This is to ensure the quantity of fuel dispensed and to protect the end user.

In the present embodiment, an area controller 7 is interposed between the forecourt terminal 5 and each dispenser 6 to manage the sending and receiving of signals between themselves. In one embodiment, by means of software included in the forecourt terminal 5, each dispenser 6 is previously identified and selected by an identification code.

The controller of the area 7 is configured to send activation/deactivation control signals to the dispensers 6 by means of the identification code, and to acquire data signals for detecting the quantity of fuel dispensed for each dispenser 6. Each dispenser 6 comprises a measurement detector which are substantially scales, of the conventional type, and is not highlighted in the drawings.

The forecourt terminal 5 comprises a first local control module 8 equipped with a first microprocessor processing unit 9, which is associated with a first memory unit 10 and with a first communication unit 11.

The first local control module 8 is configured to receive signals from at least one user interface 12 that defines a quantity of fuel to be dispensed from a selected dispenser 6. Of course, the user interfaces can be a plurality arranged in further slave-type terminals, present in the forecourt area 4 and managed by said first local control module 8.

The first processing unit 9, through the area controller 7, sends respective control signals for the selected dispenser 6 and receives data regarding the activation/deactivation signals of the dispenser 6 and the datum regarding the actual quantity of fuel dispensed.

The first processing unit 9 stores the data included in the received signals in the first memory unit 10. The first memory unit 10 stores the data in a stable non-volatile and permanent manner even without being powered by a permanent power source.

In one embodiment, the area controller 7 comprises a multiplexer device adapted to control a series of converter modules for converting the control signals, which are sent by the first processing unit 9, into respective control signals adapted to control the various electronic control heads of the dispensers 6. In this way, the dispensers 6 are uniquely controlled by the first processing unit 9 and can be made by different manufacturers with electronic control heads that are different from each other.

The remote management centre 2 comprises a central control module 20 equipped with a central processing unit 21, with a microprocessor, in communication with a central memory unit 22 and with a central communication unit 23 adapted to send and receive signals through the communication network 30.

According to one embodiment, the central control module 20 is realised in a specific platform and communicates with the first communication unit 11 to send and receive signals in a secure mode. The communication between the central communication unit 23 and the first communication unit 11 occurs bidirectionally. An appropriate and proprietary communication protocol is used to optimise the two-way management and the exchange of information on the communication network 30.

In particular, the central processing unit 21 receives signals comprising the data stored in said memory unit 10, through the first processing unit 9, and stores these data in said central memory unit 22.

According to one embodiment, the first processing unit 9, by means of a certification algorithm and using the data included in the first memory unit 10, generates a local metrological measurement certificate certifying the quantity of fuel dispensed by the service station 3 in a defined time range. According to the current legislation, the metrological certification algorithm must be declared, tested and certified by a Certifying Body in the first certification phase. Substantially, the local metrological measurement certificate is of the conventional type adapted to obtain a metrological certification of the service station 3 satisfying the stringent requirements imposed by the laws in force.

In addition, the central processing unit 21 generates by means of a verification algorithm, which can be certified by the Certifying Body during the first certification phase, a remote metrological measurement certificate certifying the data stored in the central memory unit 22.

The local metrological measurement certificate is sent to the central processing unit 21, by means of the communication network 30, and the certified data contained therein are compared with the data included in the central memory unit 22 to generate an actual remote metrological certificate of the quantity of fuel dispensed by the service station 3 in a defined time range.

In this way, the remote management centre 2 certifies the remotely stored data with the verification and the control of the data of the service station 3, which stored in the first memory unit 10, are maintained in the forecourt area 4.

This control allows the actual remote metrological certificate generated to be defined as reliable.

The remote management centre 2 comprises an operational interface 24 associated with the central processing unit 21 and configured for remote and real-time display of the operation of the service station 3. In addition, the operational interface 24 is configured to control and/or modify through the central processing unit 21 each device present in the forecourt area 4.

In one embodiment, the central memory unit 22 is updated, substantially in real time, with the memory unit 10 by using a specific communication protocol.

Other devices present in the forecourt area 4, such as price board 50 and level sensors 51, which are included in each fuel tank, are associated with the first local control module 8, by means of the local area network, and are managed and controlled by the central control module 20.

The management and the control of all the devices present in the forecourt area 4 is of the remote type and takes place through the central control module 20 and the operational interface 24, of the remote management centre 2, which communicates with the first control module 8 with the two-way communication network 30.

Mobile devices 25, such as a computer, tablet or mobile phone, access the operational interface 24, preferably through a connection to a secure network, by displaying the real-time operation of the service station 3.

Furthermore, a remote assistance station 26, through a connection on a shared network such as for example a private network of the MPLS type (acronym for Multiprotocol Label Switching), accesses the central control module 20 and controls/modifies the devices included in the forecourt area 4 through the communication network 30, the local control module 8 and the area controller 7.

In this way, the forecourt terminal 5, the area controller 7 and also the dispensers 6, the price board 50 and/or any and further devices, such as, for example, automatic washing devices and/or distributors of cleaning materials or other that may be present in the forecourt area 4, are managed and controlled remotely through the central control module 20 and the operational interface 24.

As regards operation, the remote management centre 2 manages, with a remote control mode, the advanced system 1 by initializing the devices present in the forecourt area 4 with a remote initialization procedure which is controlled by the central control module 20. Subsequently, each event and in particular each refuelling carried out through a dispenser 6 is recorded in the memory unit 10 of the local control module 8. Then, the data relating to the quantity of fuel dispensed and to the dispenser 6 are sent from the local communication unit 11 to the central control module 20, through the communication network 30, and then stored in the central memory unit 22.

The local control module 8 generates the local metrological measurement certificate and sends it to the central control module 20. The central processing unit 21 certifies the data stored in the central memory unit 22 by generating the actual remote metrological certificate of said quantity of fuel dispensed by the service station 3. Data transmission from the local control module 8 to the central control module 20 can take place in real time or in a given time range.

An automation of the advanced service station system 1 has therefore been achieved whereby thanks to the central control module 20 and to the communication with two-way management with the first local control module 8 and to the verification of all received data from the forecourt area. Such automation allows the actual remote metrological certificate to be generated certifying the local forecourt data stored in the memory unit 10 and allowing a metrological foreseen of the forecourt area to be obtained. In fact, the quantity of fuel dispensed is certified processing the values of the level sensors 51 of each fuel tank, the prices in the price board 50 and further signals and/or values. During the processing and the comparison of the data, the central processing unit 21 can detect any anomalies and activate predefined alert procedures. In addition, thanks to the operational interface 24 and to the central processing unit 21 all devices present in the forecourt area 4 are remotely controlled.

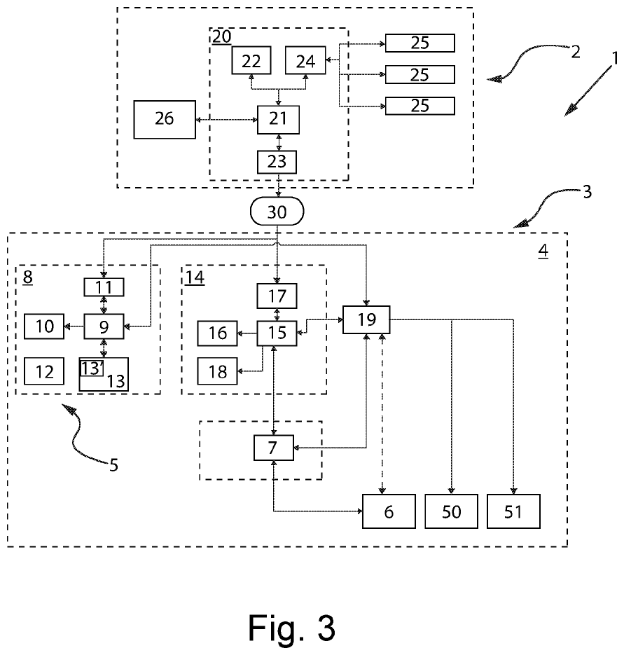

A second embodiment of an advanced system 1 is illustrated in FIG. 3, for which details and parts having the same structure and function as the previous embodiment example will be indicated with the same reference numbers and abbreviations.

In addition to the embodiment described above, the advanced system 1 comprises a second local control module 14 arranged in said forecourt area 4. The second local control module 14, similarly to the first local control module 8, is equipped with a second microprocessor processing unit 15, associated with a second memory unit 16 and a second local communication unit 17. The second memory unit 16 allows the received data to be stored in a binding, stable and permanent manner.

In the present embodiment, the local network comprises a switch element 19 which is interposed between the first communication unit 11 of the first control module 8 and the area controller 7 which is associated with at least one dispenser 6.

The switch element 19 is also interposed between the second processing unit 15 and the area controller 7.

In the case where the dispensers 6 are two or more, the area controller 7 comprises a multiplexer device and is interposed between the second processing unit 15 and said dispensers 6 to send and receive signals from different types of dispensers 6.

In the present embodiment, the first local control module 8 comprises a first temporary management unit 13 associated with the first processing unit 9 and the second local control module 14 comprises a second temporary management unit 18 associated with the second processing unit 15.

The first temporary management unit 13 and the second temporary management unit 18 are activated when the communication with the remote management centre 2 through the communication network 30 is interrupted.

The remote management centre 2 is substantially similar to what described above.

In terms of operation, the local control module 8 receives signals from two or more user interfaces 12 configured to define a quantity of fuel to be dispensed from respective dispensers 6. The local control module 8 generates respective control signals including an identification code of the dispenser 6 selected by the user. The dispenser 6 receives the control signal from the area controller 7 through the switch element 19.

The second local control module 14 is configured to acquire and to store in the second memory unit 16 the data relating to the activation/deactivation signals of each dispenser 6 sent by the area controller 7 and the data relating to the actual quantity of fuel dispensed.

Through the second processing unit 15 and the switch element 19, the data stored in the second memory unit 16 are sent to the first control module 8 and stored in the memory unit 10. In this way, the second memory unit 16 and the memory unit 10 store, substantially in real time, the data and all the activation/deactivation information relating to the local deliveries by each dispenser 6.

Then, the second processing unit 15 through the second local communication unit 17 sends the data and all activation/deactivation information related to the local deliveries by each dispenser 6 to the central control module 20 through the communication network 30. Data and information are stored in the central memory unit 22.

The second processing unit 15 controls each dispenser 6 by processing the signals received through the area controller 7 and detecting any anomalies in order to implement all the required procedures.

In addition, the first processing unit 9 through the switch element 19 communicates with other forecourt devices by sending and receiving event-related signals. The devices include the price board 50 and the level sensors 51 included in each fuel tank present in the forecourt area 4.

The signals generated by each event in forecourt area 4 comprise all the information necessary to identify the device that generated the signal and the time in which the signal was received by the first processing unit 9.

The first processing unit 9 through the first local communication unit 11 sends the signals generated by each event in the forecourt area 4 to the central control module 20. The signals generated are then stored in the central memory unit 22.

In the present embodiment, the first local communication unit 11 and the second local communication unit 17 both communicate substantially independently with each other with the central communication unit 23 by means of a respective router and a communication protocol.

The second processing unit 15 generates, by means of the certification algorithm and by using the data included in the second memory unit 16, a local metrological measurement certificate certifying the quantity of fuel dispensed by the service station 3 in a defined time range.

The local metrological certificate is sent to the central processing unit 21, by means of the communication network 30 and by means of the switch element 19 to the first processing unit 9.

The first processing unit 9, by means of a control algorithm, compares the data included in the received local metrological certificate with the data stored in the first memory unit 10 and if the comparison is positive it sends a positive verification signal to the central processing unit 21 through the communication network 30.

The central processing unit 21, by means of a verification algorithm, generates a remote metrological certificate.

The central processing unit 21, by means of a reliability algorithm, verifies that the data included in the local metrological certificate correspond to the data stored in the central memory unit 22 and also controls the positive verification signal sent by the local control module 8 generating with double check an actual remote metrological certificate. The actual remote metrological certificate is generated remotely by the remote management centre 2 certifying the data that are stored locally in the second memory unit 16 and in the first memory unit 10.

The data included in the second memory unit 16 and in the central memory unit 22 are individually certified in real time or certified in bulk at defined times or on request.

At the operational level and according to one embodiment, the remote management centre 2 manages the advanced system 1 with the remote control mode. In particular, the devices present in the forecourt area 4 are initialized by means of the initialization procedure remotely.

In one embodiment, the initialization configurations of the devices present in the forecourt area 4 are sent, through the communication network 30, from the remote management centre 2 and are also stored in the second memory unit 16 and in the first memory unit 10.

Subsequently, each event and in particular each refuelling carried out through a dispenser 6 is stored in the second memory unit 16 and is sent, through the switch element 19, to the first control module 8 to be stored in the second memory unit 10 and through the communication network 30 to the remote management centre 2 to be stored in the central memory unit 22.

In all cases in which the communication network 30 is active, the advanced system 1 acts according to a remote control mode which is managed through the central processing unit 21 of the remote management centre 2.

In case the communication network 30 is inactive and therefore there is no connectivity with the remote management centre 2, a temporary mode is activated for the forecourt area 4. In the temporary mode the first local control module 8 controls the forecourt area 4. For each event within the forecourt area 4 the signals and the data continue to be stored in the same way as in the remote control mode and therefore stored in the second memory unit 16 and/or in the first memory unit 10. Suitably in the temporary mode, the first local control module 8 activates the first temporary management unit 13 and the second local control module 14 activates the second temporary management unit 18 which allow to subsequently retrieve all the data that have been stored in the first memory unit 10 and in the second memory unit 16 during the time range of absence of connectivity.

In addition, the first temporary control unit 13 comprises a temporary interface 13′ which allows a temporary local management of the forecourt area 4. This allows a local operator to control and/or manage all the devices present in the forecourt area 4 by using the local network and a temporary communication protocol.

In the temporary mode, the second local control module 14 manages the data in a backup mode. The data exchanged in the forecourt area 4 are stored in the second storage unit 16 while the second temporary management unit 18 is configured to retrieve, subsequently to said time range of absence of connectivity, all stored backup data.

At the moment in which connectivity is present, detected through the first local communication unit 11 and the second local communication unit 17, the temporary interface unit 13′ is disabled and the remote control mode is restored. The central control module 20 takes over the control over the devices in the forecourt area 4 while the first temporary management unit 13 and the second temporary management unit 18 allows the transfer of the stored data, during the time range of absence of connectivity, to the central memory unit 22 and through the communication network 30. This allows the remote management centre 2 to remotely generate the actual metrological certification of the data.

As an alternative solution, the virtual system 1 may provide that the service station 3 presents only the remote control mode by establishing that in the time range with absence of connectivity the devices of the forecourt area 4 are kept inactive controlled by said first local control module 8.

According to a variant of the advanced system illustrated in FIG. 3, the dispensers 6 are directly connected to the local network and associated with the switch element 19 to send and to receive signals with the first processing unit 9 and with the second processing unit 15. In this case the area controller 7 is networked to the switch element 19. This solution allows the dispensers 6 to be managed directly with the local network, allowing a greater operational flexibility in the forecourt area 4, simplifying the wirings and facilitating any movement/replacement of the dispensers 6.

According to a further aspect of the present disclosure, upon an event generated at time t0 by a device in the forecourt area 4, for example considering the dispensing of fuel from a dispenser 6 as event-1, the event at time t0 is the start of dispensing, the second local control module 14 acquires the datum at time t1 and sends a push notification signal to the remote management centre 2, via the communication network 30, and to the first local control module 8, via the switch element 19 and the local network. The push notification signal with the datum generated by the event-1 is preceded by a data sending alert signal. In case the communication network 30 is inactive, the service station 3 operates in temporary mode and when connectivity is restored the remote control mode is reactivated. The remote management centre 2 sends a request signal with a push notification for the availability to receive the data stored in the second memory unit 16 so as to subsequently generate the actual remote metrological certificate of the data.

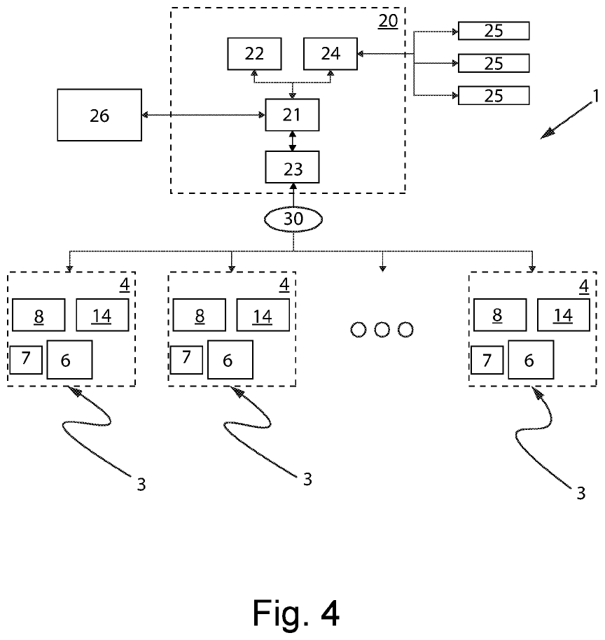

As illustrated in FIG. 4, the remote management centre 2 can manage a plurality of service stations 3 in parallel. In such a case, the central processing unit 21 and the central memory unit 22 are configured to enable the control mode remotely and individually for each service station 3, so that a corresponding actual remote metrological certificate is generated for each service station 3. The temporary mode is also managed in parallel, individually and separately, for each service station 3.

The present disclosure also relates to a remote control process of a service station 3 equipped with a forecourt area 4 and which comprises a forecourt terminal 5 associated with at least one local memory unit, 10 and 16, and with at least one dispenser 6.

The control process provides for:
sending control signals to said at least one dispenser 6 to receive at least an actual datum of the actual quantity of fuel dispensed by said dispenser 6;
storing said at least one actual datum in said at least one local memory unit, 10 and 16;
generating a local metrological certificate using said at least one actual datum.

It is provided for comprising a remote management centre 2 with a central control module 20 equipped with a central memory unit 22.

The control process provides for:
sending a signal comprising the at least one actual datum to said central control module 20 by storing said actual datum in said central memory unit 22;
generating a remote metrological certificate using the at least one actual datum stored in said central memory unit 22;
associating the remote metrological certificate with the local metrological certificate and verifying the data contained by generating, with double-check, an actual remote metrological certificate of the actual quantity of fuel dispensed by the at least one dispenser 6.

The control process also provides for the remote management centre 2 to be arranged remotely with respect to said forecourt area 4 and for providing a communication at least between the forecourt terminal 5 and the remote management centre 2 through a communication network 30.

The control process comprises:
receiving from the central control module 20 initialization signals for initialising the forecourt terminal 5 and the at least one dispenser 6.

In addition, the control process comprises:
activating a temporary management mode of the forecourt area 4 in a time range with absence of connectivity between said forecourt area 4 and said remote management centre 2;
associating at least one temporary management unit, 13 and 18 with the forecourt terminal 5;
activating the at least one temporary management unit, 13 and 18, during said time range;
recovering all the actual data stored in said at least one memory unit, 10 and 16, during said time range using the at least one temporary management unit, 13 and 18.

The virtual system of the service station and the control process as described have considerable advantages.

The virtual system allows the service station to be automated through the remote management centre, enabling a total virtual management and at the same time enabling an actual remote metrological certificate to be generated with double check, certifying the local data stored in the at least one memory unit included in the forecourt area. This allows any fraudulent actions to be recognized remotely. Fraudulent actions are verifiable both with respect to the quantity of fuel delivered by the regulators and with respect to the quantity and type of fuel in the tanks of the forecourt area.

In addition, thanks to the operational interface present in the remote management centre and through the two-way communication between the service station and the remote management centre, the forecourt area is virtually displayed and updated in real time with any event in the forecourt area. This makes it possible in particular to obtain a virtual control over the entire forecourt area. The remote virtualisation of the service station allows any software update to be carried out remotely to all devices included in each forecourt area. The remote control allows these updates to be started in substantially parallel mode and in total safety, with considerable cost and time savings.

In the absence of connectivity with the remote management centre, the temporary management mode of the forecourt area, thanks to the temporary management units, allows to update and temporally align the data included in the memory units locally and remotely so as to ensure the remote certification of the local data stored in the memory unit included in the forecourt area.

The advanced system and the process described, with a double certification of the data, makes it possible to supervise the forecourt area metrologically certifying the quantities delivered in relation at least to the prices displayed and the type of product delivered. Furthermore, the system and the process described makes it possible to overcome a technical prejudice by meeting the requirements required by the laws in force in the particular sector of service stations where the data, in order to be certified, must be maintained in the forecourt area. The embodiments described allow a total remote management of one or a plurality of service stations.

1. An advanced service station system comprising:
a service station equipped with a forecourt area comprising a forecourt terminal associated with at least one memory unit and at least one dispenser, said forecourt terminal being configured to send control signals to said at least one dispenser and to receive at least one actual datum that detects an actual quantity of fuel dispensed by said at least one dispenser, said at least one actual datum being stored in said at least one memory unit and used to generate a local metrological certificate of said actual quantity of fuel dispensed;
the system comprising:
a remote management centre which comprises a central control module equipped with a central memory unit, said central control module being configured to receive a signal comprising received data stored in said at least one memory unit, said received data comprising said at least one actual datum and data correlated to said at least one actual datum and to said at least one dispenser, said central control module being configured to store said received data in said central memory unit and to process said received data in order to generate a remote metrological certificate of said at least one actual datum,
said central control module being further configured to receive said local metrological certificate and to compare the data of said remote metrological certificate with the data of said local metrological certificate allowing to generate an actual remote metrological certificate of said actual quantity of fuel dispensed.

2. The advanced system according to claim 1, wherein said local metrological certificate which is generated in said forecourt area and said remote metrological certificate which is generated in said remote management centre are obtained by metrological certification algorithms.

3. The advanced system according to claim 1, wherein said remote management centre is arranged remotely with respect to said forecourt area and communicates with at least said forecourt terminal by sending and receiving signals through a communication network.

4. The advanced system according to claim 1, wherein said forecourt terminal comprises a first local control module equipped with a first microprocessor processing unit associated with a first memory unit and with a first communication unit and by the fact of comprising an area controller interposed between said first local control module and said at least one dispenser to process the signals sent between each other.

5. The advanced system according to claim 4, wherein said remote management centre comprises a central control module equipped with a central microprocessor processing unit associated with said central memory unit and with a central communication unit adapted to send and receive signals through said communication network at least to said forecourt terminal.

6. The advanced system according to claim 5, further comprising:
a second local control module arranged in said forecourt area and comprising a second microprocessor processing unit which is associated with a second memory unit and a second local communication unit,
a switch element which is interposed between the first communication unit of said first control module and said area controller, said switch element being further interposed between said second processing unit and said area controller, said second processing unit being configured to control said at least one dispenser by processing the signals received from the area controller and/or from said switch element, said signals sent by said at least one dispenser being also sent to said first processing unit.

7. The advanced system according to claim 6, wherein said first local communication unit and said second local communication unit communicate substantially independently with each other with said central communication unit, said second processing unit generating said local metrological certificate using said at least one actual datum included in said second memory unit, said local metrological certificate being sent using said switch element to the first processing unit and being sent using said second local communication unit to said central processing unit, said first processing unit being configured to control that said at least one actual datum included in said local metrological certificate corresponds to said at least one actual datum stored in said first memory unit and if said control is positive, to send a positive verification signal to said central processing unit, said central processing unit being configured to generate said actual remote metrological certificate considering said positive verification signal.

8. The advanced system according to claim 6, wherein said first local control module comprises a first temporary management unit associated with the first processing unit and the second local control module comprises a second temporary management unit associated with the second processing unit, said first temporary management unit and said second temporary management unit being configured to be activated during a time range with absence of connectivity with said remote management centre, and/or in that during said time range a temporary mode is activated in said forecourt area in which said first local control module is configured to control said forecourt area.

9. The advanced system according to claim 8, wherein said first temporary management unit and said second temporary management unit are activated and are configured to retrieve all actual data stored respectively in said first memory unit and in said second memory unit during said time range with absence of connectivity, said second local control module being configured to manage said actual data stored during said time range with absence of connectivity in a backup mode by subsequently sending said actual data to said central memory unit, said first temporary management unit comprising a temporary interface configured for management locally and in a temporary mode of said forecourt area.

10. The advanced system according to claim 4, further comprising a plurality of dispensers equipped with various electronic control heads, said area controller comprising a multiplexer device adapted to control a series of converter modules for converting the control signals received by said first processing unit into respective control signals adapted to control each head of said different electronic control heads of said plurality of dispensers.

11. A remote control process of a service station equipped with a forecourt area which comprises a forecourt terminal associated with at least one local storage unit and at least one dispenser, the control process providing for:
sending control signals to said at least one dispenser to receive at least an actual datum of the actual quantity of fuel dispensed by said dispenser;
storing said at least one actual datum in said at least one local memory unit;
generating a local metrological certificate using said at least one actual datum;
further including:
providing a remote management centre comprising a central control module equipped with a central memory unit;
sending, to said central control module, a signal with received data comprising said at least one actual datum and data correlated to said at least one actual datum and to said at least one dispenser, said received data being stored in said at least one local memory unit;
generating a remote metrological certificate processing said received data;
receiving said local metrological certificate;
associating said remote metrological certificate to said local metrological certificate and controlling that the data of said remote metrological certificate correspond to the data of said local metrological certificate to generate an actual remote metrological certificate of said actual quantity of fuel delivered.

12. A control process according to claim 11, including the following steps:
remotely arranging said remote management centre with respect to said forecourt area;
providing for a communication between at least said forecourt terminal (5) and said remote management centre through a communication network;
receiving from said central control module initialization signals for initializing said forecourt terminal and said at least one dispenser;
activating a temporary management mode of said forecourt area in a time range with absence of connectivity with said remote management centre;
associating at least one temporary management unit with said forecourt terminal;
activating said at least one temporary management unit during said time range with absence of connectivity;
recovering all the actual data stored in said at least one memory unit during said time range with absence of connectivity using said at least one temporary management unit.
